(19) United States
(12) Patent Application Publication
(10) Pub. No.: US 2016/0189213 A1
(43) Pub. Date: Jun. 30, 2016

(54) Systems and Methods for Targeting Advertising based on Future Purchases

(71) Applicant: Green Dot Corporation, Panadena, CA (US)

(72) Inventors: Ajith Gopalan, Pasadena, CA (US); David Gullett, Pasadena, CA (US); Calvin Park, Pasadena, CA (US); Kuan Archer, Pasadena, CA (US)

(73) Assignee: Green Dot Corporation

(21) Appl. No.: 14/587,931

(22) Filed: Dec. 31, 2014

(51) Int. Cl. G06Q 30/02

(52) U.S. Cl. CPC G06Q 30/0255

(57) ABSTRACT

Systems and methods for targeting advertising based on indicated future purchases n accordance with embodiments of the invention are disclosed. In one embodiment, a method for targeting advertising includes obtaining target product data using an account servicing server system, wherein the target product data includes a set of attribute/value pair data describing a target product, obtaining target product account data using the account servicing server system, wherein the target product account data includes target product account balance data describing the funds available to spend on the target product using a prepaid card, generating targeting data based on the target product data and the target product account data using the account servicing server system, obtaining advertising data based on the targeting data using the account servicing server system, and providing the advertising data using the account servicing server system.

### FIELD OF THE INVENTION

The present disclosure relates generally to financial services systems, and relates, more particularly, to advertising based on financial transactions.

### BACKGROUND

The financial services industry provides a plethora of financial services to consumer accounts for managing their finances and engaging in financial transactions with retailers and service providers. Consumer accounts may hold funds within many different types of accounts at many different types of financial institutions. Consumer accounts may access the funds held in the accounts using many different types of cards, including credit cards, debit cards, gift cards, and other types of cards based on the particular type of account associated with the card. The cards may be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for targeting advertising based on indicated future purchases in accordance with embodiments of the invention are disclosed. In one embodiment, a method for targeting advertising includes obtaining target product data using an account servicing server system, wherein the target product data includes a set of attribute/value pair data describing a target product, obtaining target product account data using the account servicing server system, wherein the target product account data includes target product account balance data describing the funds available to spend on the target product using a prepaid card, generating targeting data based on the target product data and the target product account data using the account servicing server system, obtaining advertising data based on the targeting data using the account servicing server system, and providing the advertising data using the account servicing server system.

In another embodiment of the invention, the method further includes obtaining transaction data using the account servicing server system, wherein the transaction data includes metadata describing that a financial transaction has been denied and product data describing the target product to be purchased via the financial transaction, determining that an offer associated with the advertising data corresponds to the target product to be purchased using the account servicing server system, calculating overage data based on the transaction data and the target product data, wherein the overage data includes an amount to authorize in the transaction, and transmitting transaction authorization data using the account servicing system.

In an additional embodiment of the invention, the transaction data is obtained from a payment processor system.

In yet another additional embodiment of the invention, the transaction authorization data is transmitted to a financial institution system, wherein the financial institution system holds the account associated with the prepaid card.

In still another additional embodiment of the invention, the amount described in the overage data is equivalent to the amount of the discount applied to the product to be purchased calculated based on price data describing the cost of the target product and the offer data.

In yet still another additional embodiment of the invention, the method further includes transmitting deposit data to a financial institution system holding the account associated with the prepaid card using the account servicing server system, wherein the deposit data includes an amount of money to be deposited into the account based on the offer data, and the transaction authorization data includes instructions to a payment processor system to re-execute the financial transaction.

In yet another embodiment of the invention, the transaction authorization data includes metadata describing an authorization to allow an overage on the financial transaction based on the offer data.

In still another embodiment of the invention, the method further includes identifying a client device associated with the prepaid card based on the financial transaction data using the account servicing server system, and the advertising data is provided to the client device.

In yet still another embodiment of the invention, providing the advertising data further includes transmitting the targeting data to a third party advertising system using the account servicing server system, and transmitting the advertising data to the client device using the third-party advertising system.

In yet another additional embodiment of the invention, generating targeting data further includes identifying at least one offer in a set of offer data including offer keywords corresponding to the attribute/value pair data in the target product data using the account servicing server system, and generating the targeting data based on the offer keywords and the target product data using the account servicing server system.

In still another additional embodiment of the invention, the offer data is obtained from a retailer system.

In yet still another additional embodiment of the invention, the offer data is obtained from a third-party advertising system.

In yet another embodiment of the invention, the target product data further includes price data describing the price of the target product and generating the targeting data is further based on the price data and the target product account balance data.

In still another embodiment of the invention, the method further includes calculating the difference between the price data and the target price account balance data using the account servicing server system.

In yet still another embodiment of the invention, the target product data further includes location data describing the location of the target product and generating the targeting data is further based on the location data.

In yet another additional embodiment of the invention, obtaining advertising data further includes generating the advertising data based on the targeting data using the account servicing server system.

In still another additional embodiment of the invention, obtaining advertising data further includes transmitting the targeting data to a third-party advertising system using the account servicing server system, and receiving the advertising data from the third-party advertising system using the account servicing server system.

In yet still another additional embodiment of the invention, the advertising data is provided by the account servicing server system.

In yet another embodiment of the invention, the advertising data is provided by a retailer system.

Still another embodiment of the invention includes an account servicing server system including a processor and a memory connected to the processor and storing an account servicing application, wherein the account servicing application directs the processor to obtain target product data including a set of attribute/value pair data describing a target product, obtain target product account data including an indication of the funds available to spend on the target product, generate targeting data based on the target product data and the target product account data, obtain advertising data based on the targeting data, and provide the advertising data.

### BRIEF DESCRIPTION OF THE DRAWINGS

FIG. 1 is a conceptual illustration of an account servicing system in accordance with an embodiment of the invention.

FIG. 2 is a conceptual illustration of an account servicing server system in accordance with an embodiment of the invention.

FIG. 3 is a flow chart illustrating a process for targeting advertising in accordance with an embodiment of the invention.

FIG. 4 is a flow chart illustrating a process for funding a product account in accordance with an embodiment of the invention.

FIG. 5 is a flow chart illustrating a process for identifying a targeting opportunity in accordance with an embodiment of the invention.

FIG. 6 is a flow chart illustrating a process for presenting advertising data in accordance with an embodiment of the invention.

FIG. 7 is a flow chart illustrating a process for fulfilling a transaction in accordance with an embodiment of the invention.

### DETAILED DESCRIPTION

Turning now to the drawings, systems and methods for targeting advertising based on indicated future purchases in accordance with embodiments of the invention are disclosed. Account servicing systems in accordance with many embodiments of the invention can detect account activity and target advertising to client devices associated with the active accounts based upon location information associated with or implied by the account transactions (e.g. the location of a point of sale) and/or available account balances. In this way, the account servicing systems can allow advertisers to programmatically target advertisements based upon the location of a consumer account and the funds available to the consumer account (i.e. the pre-paid card account associated with the consumer account). In several embodiments, the account servicing systems directly target advertising to consumer accounts and/or client devices associated with consumer accounts. In a number of embodiments, the account servicing systems provide information identifying consumer accounts and/or client devices associated with consumer accounts as targets to advertising networks that target advertisements to the identified consumer accounts. Prepaid cards allow consumer accounts to load funds onto their account at a variety of participating locations, such as retailers. Funds can be loaded onto a prepaid card (i.e. deposited into an account associated with the prepaid card) through various mechanisms, including direct-deposit, check deposit, wire transfers, online deposits, cash deposits, and any other techniques as applicable to the requirements of specific embodiments of the invention. Consumer accounts can then use the prepaid cards in a manner similar to traditional debit and/or credit cards to purchase goods using the funds that have been loaded onto the account.

Account servicing server systems in accordance with a variety of embodiments of the invention allow consumer accounts to identify particular goods that they wish to purchase. In many embodiments, the account servicing server systems facilitate the establishment of savings accounts for each of the identified goods. Funds that are loaded onto a prepaid card can then be allocated, either manually or automatically, to the savings account for a particular good. When a consumer account uses the prepaid card to purchase the identified good, the funds to purchase the good can then be taken from the savings account for that good. Account servicing systems can utilize a variety of data such as, but not limited to, demographic information regarding the consumer account, the prepaid card, and/or the identified goods, to provide targeting information to a variety of retailers and/or advertisers. In a variety of embodiments, the targeting information is utilized to target advertising to particular consumer accounts.

Unlike other marketing mechanisms that provide coupons to consumer accounts through newspapers, mailings etc. and thus require a consumer account to remember carrying the physical coupon and redeeming it at the retailer, presenting advertisements upon detecting the consumer account's presence at a retailer may increase the likelihood that a consumer account will actually use the offer, thereby driving additional business to a particular retailer. Account servicing server systems can also generate and/or obtain advertising campaigns and/or targeting information. Advertising data can be transmitted to user devices associated with the prepaid card. Targeting data can be provided to any of a variety of advertising systems in order to obtain advertising data or otherwise cause advertising data to be transmitted to a user device. In a number of embodiments, the advertising data can be displayed when a consumer account is located proximate to a particular retail location. Additionally, the advertising data can be displayed based on the reload activity associated with the prepaid card. For example, advertising data related to a particular good that is sold at a retailer can be displayed when the consumer account loads funds onto a prepaid card using a terminal at the retailer. By providing a consumer account with an advertisement and/or coupon, account servicing server systems can provide the consumer account with an offer at an opportune time that is particularly useful to the consumer account. As an illustration, if a consumer account has identified a good that costs $100 and has saved $80 toward that good, a coupon can be provided to a consumer account that would make up the $20 difference and allow the consumer account to purchase the identified good.

Systems and processes for targeting advertising based on indicated future purchases in accordance with embodiments of the invention are described in more detail below.

### Account Servicing Systems

Conducting financial transactions can involve communication between many different parties (e.g., banks, processors, credit issuers, regulators, consumer accounts, etc . . . ) prior to funds being exchanged between a consumer account and a retailer. For example, a consumer account may initiate a purchase at a point-of-sale terminal of a retailer. The retailer may track certain information for the consumer account, including the items being purchased and the total purchase price and may send this information to a third party payment processor. In turn, the payment processor can communicate with a multitude of financial systems in order to process the transaction.

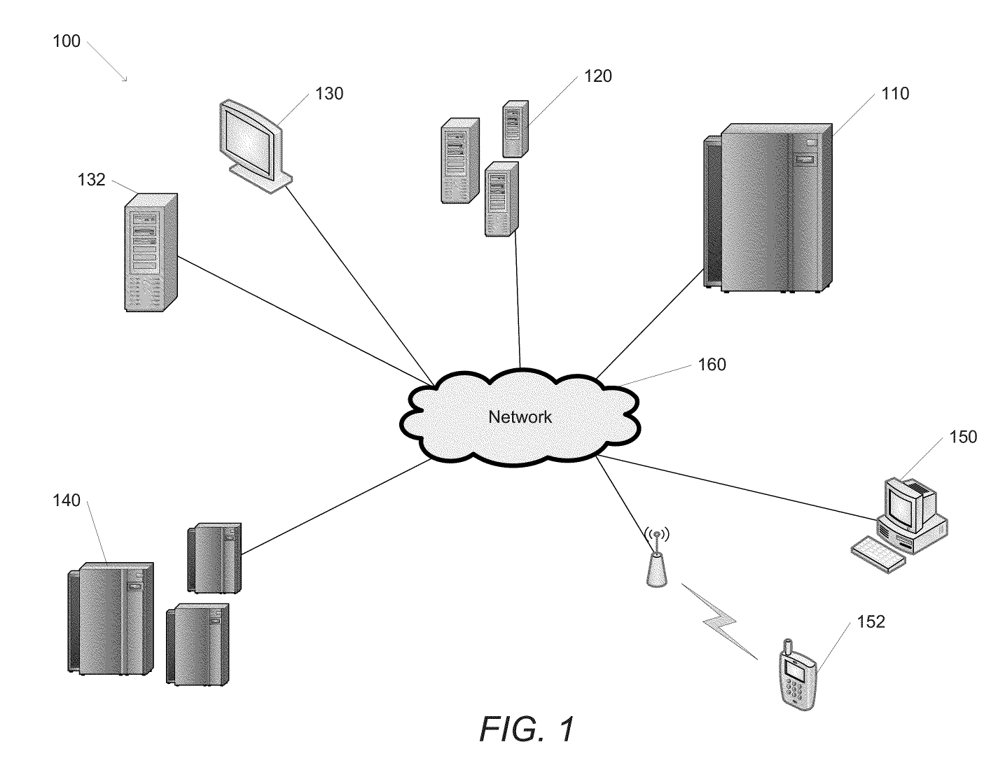

Turning now to FIG. 1, a conceptual illustration of an account servicing system in accordance with an embodiment of the invention is shown. The account servicing system 100 includes account processing server system 110, payment processor systems 120, retailer systems such as point of sale terminals 130 and retailer server system 132, financial institution systems 140, and client devices including, but not limited to, personal computers 150 and mobile devices 152. These systems communicate through one or more networks 160. Network(s) 160 can include, but are not limited to, the Internet, a local area network, a wide area network, and networks that are shared privately between only a subset of the systems. For example, the payment processor 120 can communicate with the financial institution systems 140, retailer systems, and account processing server system 110 via one or more private networks.

Account servicing server system 110 provides front-end and back-end services for creating and managing accounts for prepaid cards via a number of account servicing processes as appropriate to the requirements of specific applications of embodiments of the invention. Account servicing server system 110 can obtain account data for a prepaid card from a retailer system and/or from a user device. The account servicing server system 110 can assign the account to a payment processor system 120 and/or financial institution 140; a request that a permanent card be issued to the account holder associated with the account by the payment processor system 120 and/or financial institution 140 can also be made. The account servicing server system 110 can also communicate with the financial institution 140 and/or the payment processor system 120 to facilitate the execution of transactions between consumer accounts and retailer systems when the transaction involves the prepaid card. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide an interface providing account data, user profile data, balance data, transaction data, fee data, and any other data related to the prepaid card and/or the account as appropriate to the requirements of specific applications of embodiments of the invention. In a variety of embodiments, the account servicing server system 110 provides a listing of product data and can associate one or more pieces of product data with a user account. These selected pieces of product data can indicate target products that an account holder wishes to purchase. In a number of embodiments, the account servicing server system 110 creates target product accounts with the account servicing server system 110 and/or the financial institution 140; the target product accounts can be utilized to (automatically) hold funds to purchase the target product. For example, a user can manually transfer funds from a primary account associated with the prepaid card using the account servicing server system 110. The account servicing server system 110 can also automatically allocate a portion of a reload (e.g. a deposit) on the prepaid card to the target product account. In many embodiments, the reload is received using a retailer system (such as a point of sale terminal 130).

In several embodiments, the account servicing server system 110 provides targeting data to the retailer systems and/or receives targeting data and/or advertising data from the retailer systems. The identification of targeting opportunities can be performed based on a variety of transaction data, such as transaction data associated with a consumer account and transaction data describing a reload operation for the consumer account obtained from a point of sale terminal, although any transaction data can be utilized as appropriate to the requirements of specific applications of embodiments of the invention. As is described in more detail below, a variety of targeting options can be utilized in order to present advertising data as appropriate to the requirements of specific applications of embodiments of the invention. The targeting data can describe information about consumers that can be targeted and/or information about consumers that the retailer systems (and/or third party advertising systems) have requested as appropriate to the requirements of specific applications of embodiments of the invention. By way of a first example, targeting data can be providing to retailer systems and/or third-party advertising systems and advertising data can be obtained in response. By way of a second example, information about consumer accounts is used in combination with targeting data from retailers (i.e. advertising rule data) to determine which client devices to target. By way of a third example, a set of advertising data can be pre-loaded onto a client device and, when the client device determines that a set of conditions have been met (e.g. based on the targeting data), an advertisement can be presented based on the pre-loaded advertising data. The account servicing server system 110 can utilize targeting data and/or advertising data to present offers to the user devices. These offers can be redeemed in a variety of ways in accordance with the requirements of specific applications of embodiments of the invention, including by providing a discount on a transaction for a target product and/or crediting funds to a target product account. In this way, the account servicing server system 110 can facilitate the purchase of target products by encouraging users to use the prepaid cards at participating retailers. Advertising data can be provided by third-party advertising systems (not pictured) and/or directly by the retailer systems as appropriate to the requirements of specific applications of embodiments of the invention. In several embodiments, the advertising data is provided based on targeting data provided by the account servicing server system 110.

Retailer systems, such as point of sale terminal 130, can be used to purchase prepaid cards, load fund onto the prepaid cards, as well as process consumer account transactions that use a consumer account's prepaid card to make purchases of goods and/or services from the retailer. The point of sale terminal 130 can transmit transaction data describing the requested transaction to the retailer server system 132 and/or the processor system 120. In many embodiments, the point of sale terminal 130 communicates directly with the account servicing system 110. In a variety of embodiments, the retailer server system 132 obtains transaction data from a number of point of sale terminals 130 and transmits the transaction data utilizing techniques similar to those described above.

Payment processor system 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards (or any other account). Payment processor systems 120 provide a transaction interface that can be utilized to process transaction data. The transaction data can be obtained from any system, including the retailer system. In a number of embodiments, the payment processor system 120 processes transactions for prepaid cards (or any other account) issued by (or otherwise associated with) the payment processor system 120. Processing transaction data includes determining if a transaction should be authorized. If a transaction is authorized, funds drawn from an account associated with the prepaid card are directed to be transferred to an account associated with the retailer identified in the transaction. The transfer of funds can include transmitting requests to one or more financial institution systems 140 and/or the account servicing server system 110 in order to execute the requested transaction. In several embodiments, if the transaction is not authorized, the payment processor system 120 can request additional information from the account servicing server system 110. This additional information can then be utilized to re-process the transaction, potentially resulting in the transaction being authorized.

In a variety of embodiments, payment processor systems 120 provide one or more account servicing interfaces to communicate with the account servicing server system 110 and/or financial institution system 140. The account servicing interface can be utilized by the account servicing server system 110 to obtain and/or transmit data to and from the payment processor system 120. For example, requests to issue accounts can be obtained using the account servicing interface. Similarly, if the payment processor system 120 needs additional information in order to process a transaction, that information can be requested and obtained from the account servicing server system 110 and/or the financial institution system 140. However, it should be noted that any processes that include communication between the payment processor system 120 and other systems within the account servicing system 100 can utilize the account servicing interface as appropriate to the requirements of specific embodiments of the invention.

Financial institution systems 140 include financial accounts for one or more entities. These financial accounts hold funds on behalf of the entities and can transfer the funds to retailer systems, payment processors, account servicing server systems, or any other system as appropriate to the requirements of specific applications of embodiments of the invention. In many embodiments, financial institution systems 140 incorporate some or all aspects of the payment processor systems 120. In this way, financial institution systems can issue, service, and/or approve transactions related to prepaid cards.

Client devices can be used to manage account data associated with prepaid cards, purchase cards, add (e.g. reload) or remove funds from cards, purchase goods from a retailer, and any other transactions or operations as appropriate to the requirements of specific applications of embodiments of the invention. Furthermore, client devices can obtain and display advertising data transmitted to the device via any of a variety of techniques, including, but not limited to, on a request for advertising data, push notifications, email, short message service (SMS) messages, multimedia message service (MMS) messages. In many embodiments, the location of the client device (actual location, e.g. taken using a global positioning system receiver and/or wireless network location, and/or inferred location, based on the activity associated with the consumer account within a threshold time period) is utilized to target advertising to the consumer account. In a number of embodiments, client devices include a software application (or any other user identification data) that a consumer can sign on to in order to associate a particular consumer account with a client device. Client devices can also identify one or more products and cause a product account to be created that holds funds dedicated toward purchasing the identified product(s). In a variety of embodiments, the product accounts are described using product account data that can be referenced by and/or included in the account data. In several embodiments, the advertising data describes discounts (i.e. coupons) and/or promotions associated with one or more products described using the product account data. When the prepaid card associated with the account data is utilized to purchase the products associated with the product account data, the account servicing server system 110 provides (or causes to be provided by the payment processor system 120 and/or the financial institution 140) the necessary funds using the product account and/or the coupon described by the advertising data.

Although a specific architecture of an account servicing system in accordance with embodiments of the invention are discussed above and illustrated in FIG. 1, a variety of architectures, including user devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs) web services, and/or file-based interfaces) as appropriate to the requirements of specific applications of embodiments of the invention. Systems and processes for funding product accounts, presenting advertising, and conducting transactions in accordance with embodiments of the invention are described in more detail below.

### Account Servicing Server Systems

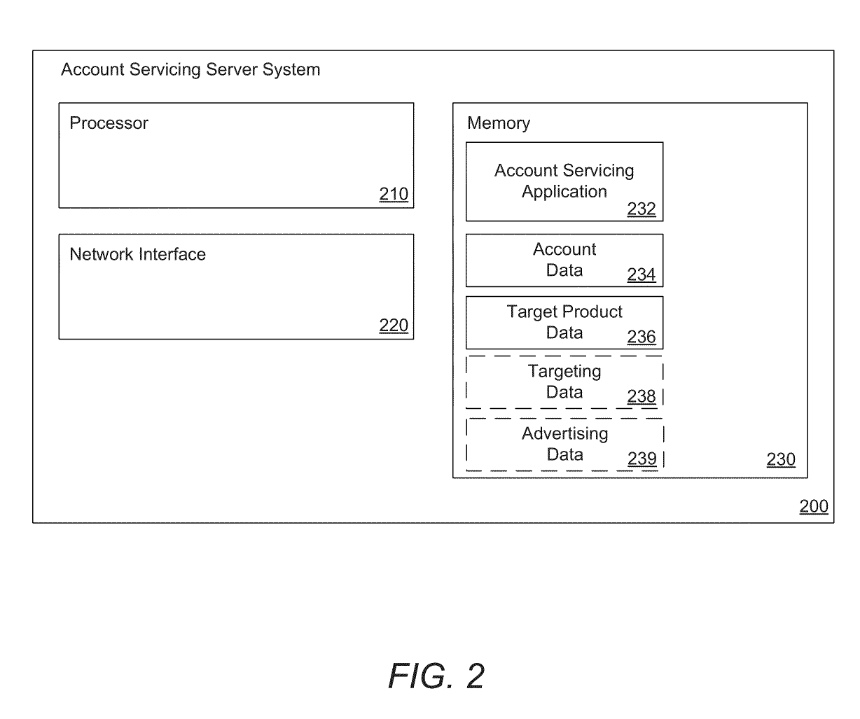

As described above, account servicing server systems can provide a variety of services for prepaid cards. One of these services includes causing advertising related to desired products to be presented to user devices associated with a prepaid card account. An account servicing server system in accordance with an embodiment of the invention is conceptually illustrated in FIG. 2. The account servicing server system 200 includes a processor 210 in communication with a network interface 220 and a memory 230. The network interface 220 is configured to send and receive data over a network connection. In a number of embodiments, the network interface 220 is in communication with the memory 230. In several embodiments, memory 230 is any form of storage configured to store a variety of data, including, but not limited to, an account servicing application 232, account data 234, target product data 236, and in a variety of embodiments, targeting data 238 and/or advertising data 239.

The account servicing application directs the processor 210 to perform a variety of account servicing processes. The account servicing processes include processing financial transactions for a consumer account, including reconciliation of debits and credits applied to a consumer account's account. The account servicing processes can also include managing account data 234 describing the consumer account's account including, but not limited to, reload activity, balance activity, and location data, consumer account profile data, demographic data, employment information, credit status, income, mailing address, and/or any other consumer account pertinent information. Account data 234 can include data received from a variety of different sources, including the consumer account, retailers, payment processor systems, financial institution systems, and any other of a variety of other sources. Furthermore, consumer accounts can be identified by a set of identifying data, such as an account number, email address, phone number, and/or user identification data that can be utilized to target data. In this way, the account data can be utilized to target uniquely identifying pieces of information associated with the consumer account. Furthermore, the account data 238 can include purchase history, credits and deposits, available balance, among any other information as appropriate to the requirements of specific applications of the invention. Account data 234 can also be associated with target product data 236. Target product data 236 describes products that a consumer account has indicated that they wish to purchase. Target product data 236 can include a variety of category data describing the category associated with a target product and/or a set of attribute/value pairs that describe the product. In several embodiments, target product data 236 further include metadata identifying one or more retailers that offer the target product for sale.

Account servicing processes can also include presenting advertisement via a client device. Advertising data 239 can be transmitted to the client device via one or more pieces of advertising data and displayed based on the location and/or balance associated with the account associated with the client device. In a number of embodiments, the advertising data 239 is transmitted to a client device based on location of the consumer account and/or prior financial transactions of the consumer account. In a variety of embodiments, advertising data is generated and/or transmitted based on targeting data 238. Targeting data includes, but is not limited to, transaction data, location data, reload activity data, balance data, target product data, or any other information that can be utilized to specifically target a consumer account (or a class of consumer accounts) as appropriate to the requirements of specific applications of embodiments of the invention. In a number of embodiments, the advertising data 239 is received and/or transmitted from an external third-party resource, such as a retailer system or an advertiser system.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. A variety of account servicing processes in accordance with embodiments of the invention are discussed further below.

### Targeting Advertising

A variety of account servicing processes include providing advertising data to a client device based on target products and/or the amount saved with respect to purchasing the target products. The advertising data can be provided to the client devices in a variety of ways as appropriate to the requirements of specific applications of embodiments of the invention. The advertising data can be transmitted directly by account servicing server systems, third-party advertising systems, and/or retailers. Additionally, advertising data can be generated based on targeting data and transmitted by any of a variety of systems as described above. In many embodiments of the invention, advertising is targeted based on products that a consumer account has indicated that they wish to purchase along with the amount of money the consumer account has saved toward the purchase of the target products. The indication can be provided in any of a variety of ways as appropriate to the requirements of specific applications of embodiments of the invention, including creating a set of target product data via a catalog of product data and placing products on layaway at a retailer. A catalog of product data can include a global set of products that can be purchased and/or a set of products provided by particular retailer(s). In a number of embodiments, the product data catalog includes a set of product data, where the product data consists of category data and/or attribute/value pairs describing the product as described above. A variety of techniques for generating targeting data in accordance with embodiments of the invention are described in more detail below.

The targeting data can be utilized to generate advertising data targeted toward the consumer account based on the target products and/or the amount of money the consumer account has. In a number of embodiments, advertisements can be selected and/or generated based on advertisement rule data associated with the retailer providing the target product for sale. For example, the advertisement rule data can specify that if a consumer account is at a particular retailer location, then to select an advertisement from a particular set of advertisements associated with the retailer. Additional criteria can be set forth to further refine the particular advertisement that is selected as appropriate to the requirements of specific applications of embodiments of the invention. In this way, the targeting data can be coupled with the advertising rule data presented by consumers to precisely target specific advertisements to specific consumer accounts. In several embodiments, the targeting data can include metadata describing the financial transaction(s), such as the amount of money reloaded onto the prepaid card, in addition to the location data and the target product data. In a number of embodiments, targeting data can be presented to third party advertisers. The third-party advertisers can be retailers, companies, service providers, and/or advertising agencies associated with the particular retail location at which the consumer account initiated the financial transaction. In a variety of embodiments, the targeting data can include user identification data and/or client device identification data. This identification data can, in many embodiments, be linked to one or more accounts provided by third-party services, such as online social networks and/or advertising networks. The identification can then be utilized by the third-party systems to further target and/or displaying advertising as appropriate to the requirements of specific applications of embodiments of the invention. For example, if the targeting data includes identification data that can be utilized to identify an online social network account, the advertising data can be displayed as a message within the online social network, either directed to the consumer's account and/or posted on the consumer's account. Similarly, advertising can be directed across a variety of websites when the targeting data includes identification data that can be utilized by an advertising network to identify a consumer (or their client device) across one or more websites.

In many embodiments, the amount of funds available for the account associated with the target product can be used to select an advertisement and/or offer. For example, the advertisement can be selected such that the items and/or services offered within the advertisement are in a price range that is within a certain threshold of the funds available on the card. Thus if a consumer account has $10 saved toward a $15 product, the advertisement can present offers for items that will allow the consumer account to make up the $5 difference between the cost of the target product and the amount saved. In a number of embodiments, as further described below, the advertisement can be selected based on the financial transactions of the consumer account. For example, if a consumer account typically purchases certain goods and/or services, the advertisement can be for those products and/or competitor products, depending on the particular advertising rules being used. By way of a second example, the advertising can be targeted toward consumer accounts that have a history of making purchases from a particular retailer, either to reward the consumer account for being loyal or to lure the consumer account to a competing retailer. Similarly, the consumer account's previous history of saving money and/or transaction history can be utilized to target advertising and/or provide custom offers to the consumer account. Advertising data can be presented to a consumer account using a client device associated with the particular prepaid card. Processes for presenting advertising data in accordance with embodiments of the invention are described in more detail below.

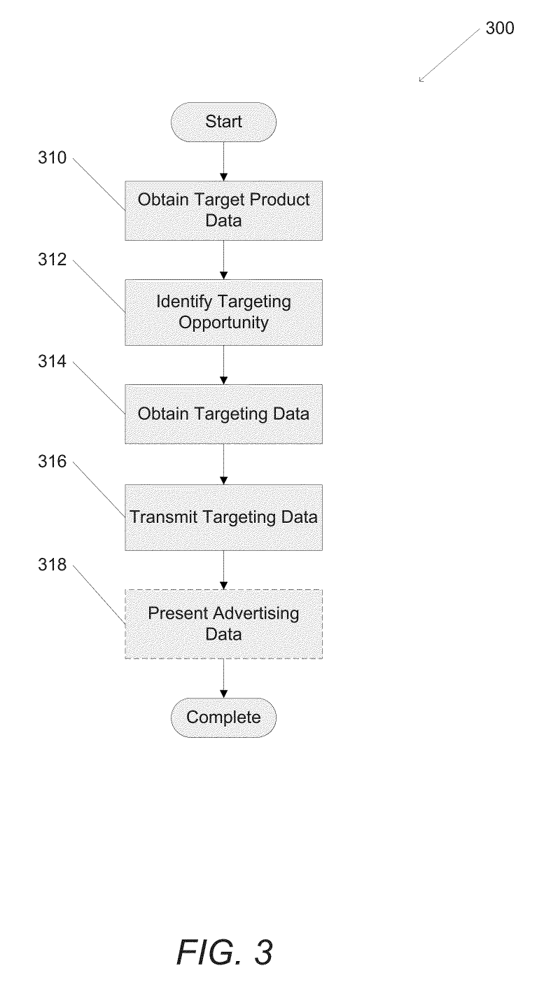

A process for targeting advertising in accordance with an embodiment of the invention is illustrated in FIG. 3. The process 300 includes obtaining (310) target product data, identifying (312) a targeting opportunity, obtaining (314) targeting data, transmitting (316) targeting data, and, in several embodiments, presenting (318) advertising data.

Processes for targeting advertising data in accordance with embodiments of the invention are discussed above; however, a variety of processes, including those that provide advertisements stored on external advertising server systems and processes that target advertising using data not specifically described above can be utilized in accordance with embodiments of the invention.

### Funding Product Accounts

Prepaid cards allow consumer accounts to automatically save a portion of the funds loaded onto the prepaid card toward the purchase of a particular target product. Account servicing processes include allocating funds to target product accounts as appropriate to the requirements of specific applications of embodiments of the invention. In many embodiments, the consumer account provides funds (cash, check, direct deposit, etc . . . ) to a point of sale terminal at a retailer. The retailer system can then transmit transaction data specifying the amount of funds to be added to the prepaid card account to an account servicing server system, a payment processor system, and/or a financial institution system as appropriate to the requirements of specific applications of embodiments of the invention. As a first example, the transaction data can be transmitted to the payment processor system associated with the prepaid card; the payment processor system can then notify the account servicing server system that the reload occurred and notify the financial institution system to deposit the funds into the appropriate account. In a second example, the account servicing server system instructs the financial institution system to deposit the funds into the appropriate account.

A number of techniques can be utilized to automatically transfer funds to a target product account as appropriate to the requirements of specific applications of embodiments of the invention. Returning to the first example, the financial institution system can maintain a set of deposit rules for a particular prepaid card account. Upon receipt of transaction data instructing the financial institution system to deposit funds into the prepaid card account, the financial institution system can deposit a first portion of the funds into the primary prepaid card account and a second portion of the funds into the target product account. Multiple target product accounts can be funded utilizing a similar technique, such as by having multiple second portions of the funds. Returning to the second example, the allocation of funds can be handled by the account servicing server system. Upon receiving the transaction data to deposit funds into the prepaid card account, the account servicing server system can generate a first deposit transaction to deposit a first portion of the funds into the primary account and generate a second deposit to transmit a second portion of the funds into the target product account. Both the first deposit transaction data and the second deposit transaction data can then be transmitted to the financial institution system for execution.

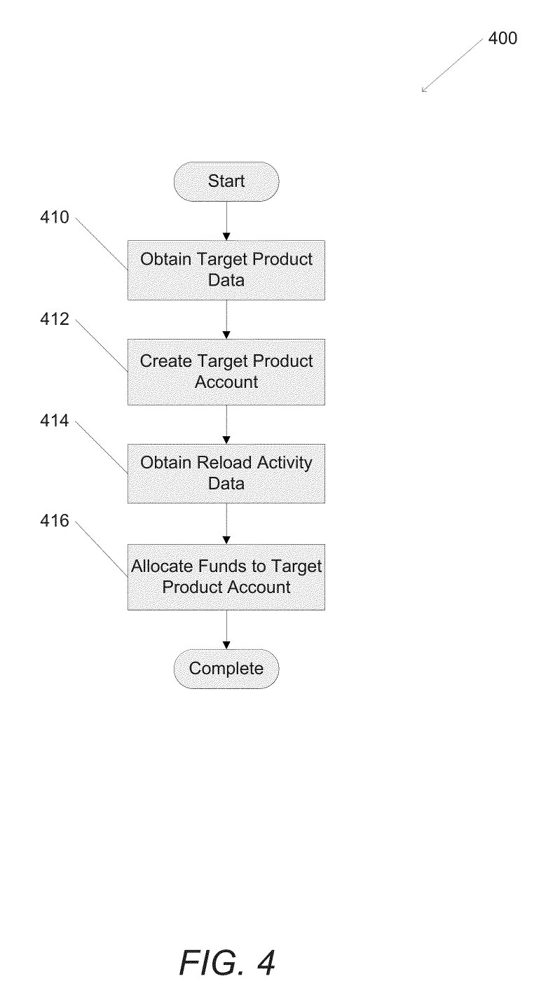

A process for funding product accounts in accordance with an embodiment of the invention is illustrated in FIG. 4. The process 400 includes obtaining (410) target product data, creating (412) a target product account, obtaining (414) reload activity data, and (416) allocating funds to the target product account. Although specific processes for funding target product accounts in accordance with embodiments of the invention are discussed above; however, a variety of processes, including those that allow consumer accounts to manually transfer funds to a particular product account and those that comingle target product funds with other funds in the consumer account's account, can be utilized in accordance with embodiments of the invention.

### Identifying Targeting Opportunities

Given data describing the goods a consumer account wishes to buy, advertising can be targeted to that consumer account. Account servicing systems in accordance with embodiments of the invention can further provide the amount of money that a consumer account has actually allocated toward purchasing a particular product along with an indication of how much that consumer account is willing to spend for the product. Account servicing processes in accordance with embodiments of the invention include identifying when consumer accounts have targeted a product for purchase and allocated funds towards that purchase. Once these conditions are met, advertising can be specifically targeted toward that consumer account and in particular, the advertising can be targeted to specific offers that cover the difference between the funds the consumer account has to spend on a target product and the cost of the target product. As described above, a portion of funds that are loaded onto a prepaid card can be earmarked for the purchase of target goods. In this way, consumer accounts can be enticed into purchasing a target product.

In several embodiments, the targeting data can be based on information regarding a notification that a consumer account is purchasing and/or reloading funds onto a card as well as data regarding the amount of money being loaded onto the prepaid card. A variety of targeting criteria can be described in the targeting data. In several embodiments, the targeting data includes category data and/or attribute/value pairs describing the target product. The targeting data can also include the current amount saved toward the purchase of the target product and/or the price of the target product. In a number of embodiments, the targeting data includes location data regarding where the consumer account has previously purchased goods and/or loads funds into the account associated with the prepaid card.

Furthermore, the targeting data can be associated with one or more retailers. In many embodiments, the target product is associated with a particular retailer; this retailer can then be provided with data describing consumer accounts and the products they wish to purchase. In this way, the retailer can drive additional business to existing consumer accounts by providing offers that allow consumer accounts to purchase goods based on the funds they have already allocated toward purchasing products. Similarly, the targeting data can be provided to competitor retailers. The competitor retailers can then provide advertising for the same or similar goods to the consumer accounts to encourage the consumer account to come to the competitor's store and spend their money. In this way, account servicing server systems can utilize their prepaid card service to provide highly targeted and valuable advertising opportunities to retailers.

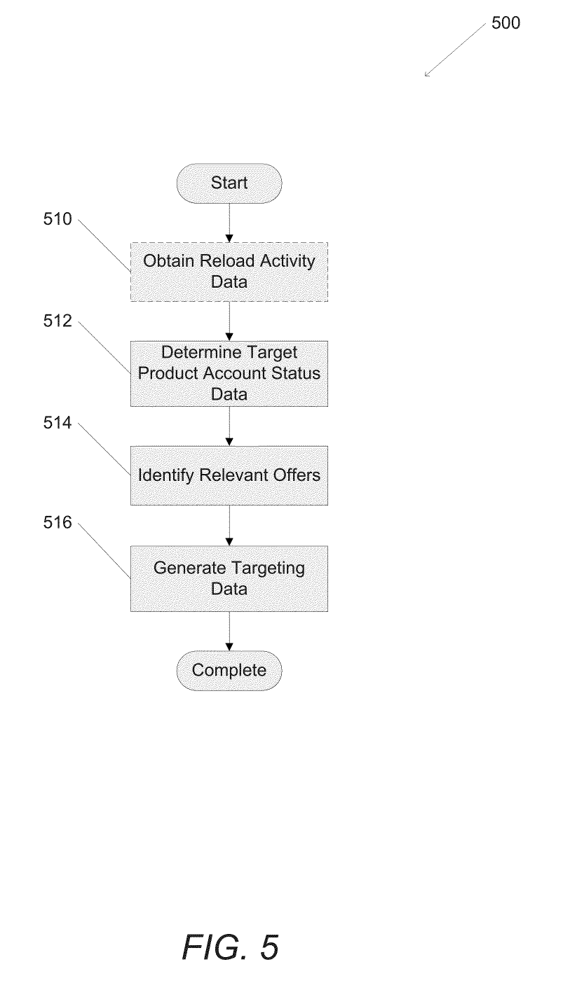

A process for identifying targeting opportunities in accordance with an embodiment of the invention is illustrated in FIG. 5. In several embodiments, the process 500 includes obtaining (510) reload activity data. The process 500 further includes determining (512) target product account status data, identifying (514) relevant offers, and generating (516) targeting data. Processes for identifying targeting opportunities in accordance with embodiments of the invention are discussed above; however, a variety of processes, including those that generate targeting data based on alternative criteria can be utilized in accordance with embodiments of the invention.

### Presenting Advertising

Targeting data can be utilized to generate the advertising data that is presented to consumer accounts. Account servicing processes include providing and presenting advertising as appropriate to the requirements of specific applications of embodiments of the invention. In several embodiments, client devices associated with a prepaid card account are utilized to present advertising data. In certain embodiments, the client device can receive any one of a text message, phone call, email message, or other notification mechanism for presenting the advertisement and/or offer. In many embodiments, the consumer account can specify the particular notification protocol utilized to present offers.

In a number of embodiments, advertising is transmitted to a location within a retailer near the detected consumer account's location and the retailer can present the offer to the client device directly. For example, if the consumer account has recently used at a point of sale terminal at a retailer to reload funds onto a prepaid card, the point of sale terminal can also provide the advertisement directly to the consumer. In particular, the advertising data can be pushed to the point of sale terminal at which the financial transaction was processed. The advertisements and/or offers can then be presented (and/or printed) and given to the consumer account within the same period and location at which the consumer account loaded funds. For example, the consumer account can purchase or reload funds to a card and be provided with a receipt of the transaction and one or more advertisements and/or offers based on the amount of funds the consumer account loaded onto the card.

In several embodiments, advertisements can be presented to the consumer account upon the consumer account requesting access to their account via a client device. In particular, some embodiments can present advertisements through a user interface provided by an online account management tool associated with the account. Advertising data can also be provided by one or more third-party advertising systems utilizing techniques similar to those described above.

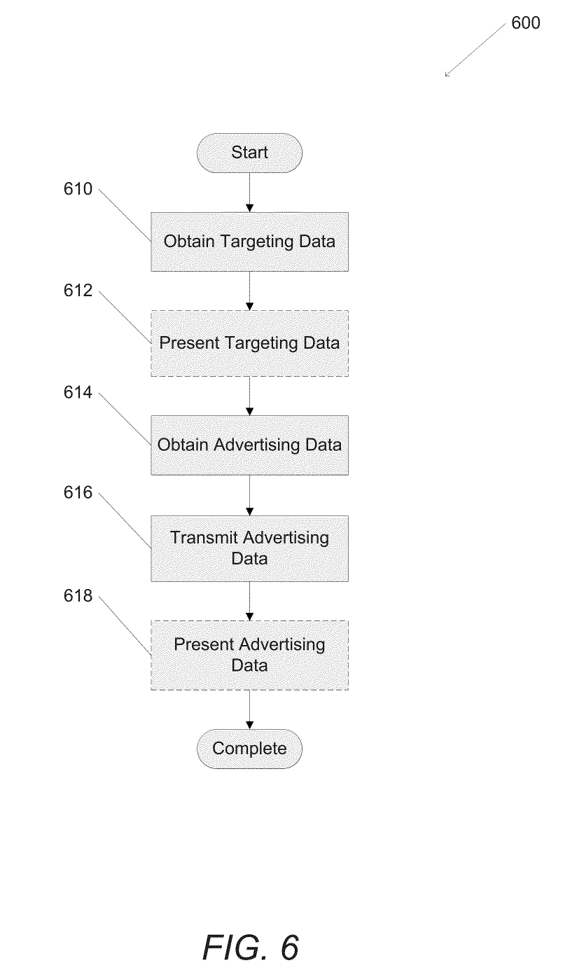

A process for presenting advertising data in accordance with an embodiment of the invention is illustrated in FIG. 6. The process 600 includes obtaining (610) targeting data and, in several embodiments, presenting (612) targeting data. Advertising data is obtained (614), transmitted (616), and in a number of embodiments, presented (618).

Although a variety of processes for presenting advertising data in accordance with embodiments of the invention are discussed above, alternative processes, including those that provide advertisements stored on external advertising server systems and processes that provide advertising data based on data in addition to the targeting data, can be utilized in accordance with embodiments of the invention.

### Fulfilling Transactions

Consumer accounts often miss savings that could otherwise have been obtained on purchases had the consumer account been aware of offers and/or offers available to them. Many consumer accounts forego this time consuming process and therefore miss many valuable savings opportunities. In several embodiments, account servicing processes include allowing consumer accounts to obtain a savings without any further action required on the part of the consumer account. As such, the consumer account can simply purchase items using their prepaid card; offers that had been presented to the consumer account can be automatically applied to these transactions and the savings automatically redeemed for the consumer account. Similarly, consumer accounts can opt-in to particular offers based on advertisements provided to the user via a client device. The advertisement can be an offer for goods and/or services. The offer can also provide an offer redeemable by any number of mechanisms, including presentation at the time of purchase. For example, the offer can be in electronic form and presentable on a mobile device of the consumer account.

In a number of embodiments, the consumer account transaction data can be received upon a consumer account engaging in a financial transaction and/or stored in a transaction database. In a number of embodiments, the transaction data can be received from one or more systems associated with the processing of the financial transaction. In a number of embodiments, the transaction data can be a list of items and/or services purchased and this information can be provided by the retailer. In particular, certain data regarding the financial transaction can be obtained from the retailer, such as the list of items being purchased. Likewise, a third-party card processor can provide a total dollar amount of the financial transaction, without being able to identify the individual items being purchased. Thus, the process can use a combination of data from different sources with respect to a financial transaction.

If one or more transactions satisfy the criteria of one or more offers, the consumer account are updated based upon the offer rewards. For example, if an offer was presented to a consumer account for 25% off a television purchased at Retailer A available for the next 3 days, the process would determine whether any transactions occurred at Retailer A for the particular type of television during the specified period. In a number of embodiments, the process can add funds to the consumer account's card account based on the offer criteria. In a variety of embodiments, the retailer system can be notified to discount the item at the time of purchase. In many embodiments, a payment processor system is instructed to authorize a transaction exceeding the balance available on the prepaid card by the amount of the offer. By automatically redeeming offers and applying offers to consumer account transactions, the consumer account can simply make purchases knowing that their outstanding offers and/or offers will be applied to the purchases.

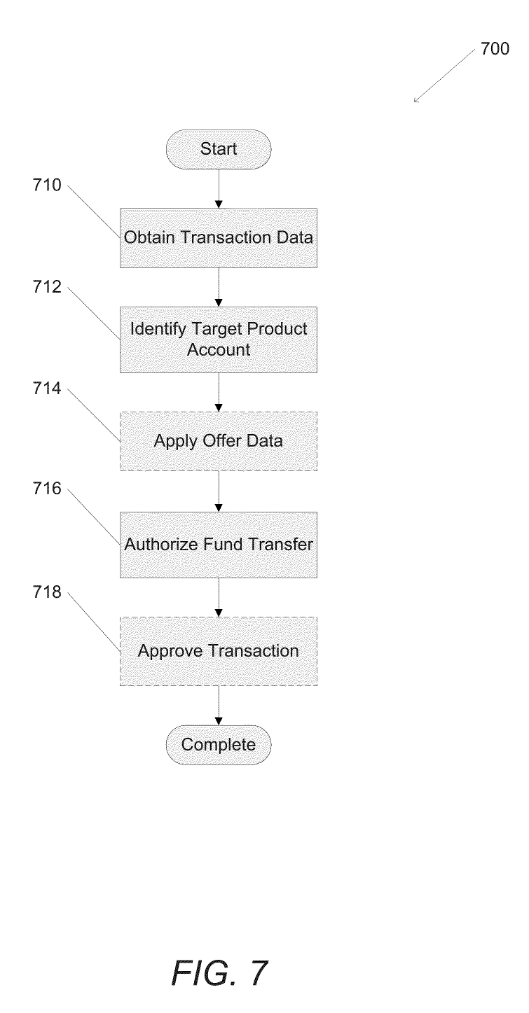

A process for fulfilling transactions in accordance with embodiments of the invention is shown in FIG. 7. The process 700 includes obtaining (710) transaction data, identifying (712) a target product account, and, in a variety of embodiments, applying (714) offer data. Fund transfer(s) are authorized (716) and, in many embodiments, the transaction is approved (718). Specific process for fulfilling transactions in accordance with embodiments of the invention are described above; however, any number of processes, including those that mark offers as redeemed and those that apply offers to transactions utilizing techniques other than those specifically described above, can be utilized as appropriate to the requirements of specific applications in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for targeting advertising, comprising:
obtaining target product data using an account servicing server system, wherein the target product data comprises a set of attribute/value pair data describing a target product;
obtaining target product account data using the account servicing server system, wherein the target product account data comprises target product account balance data describing the funds available to spend on the target product using a prepaid card;
generating targeting data based on the target product data and the target product account data using the account servicing server system;
obtaining advertising data based on the targeting data using the account servicing server system; and
providing the advertising data using the account servicing server system.

2. The method of claim 1, further comprising:
obtaining transaction data using the account servicing server system, wherein the transaction data comprises metadata describing that a financial transaction has been denied and product data describing the target product to be purchased via the financial transaction;
determining that an offer associated with the advertising data corresponds to the target product to be purchased using the account servicing server system;
calculating overage data based on the transaction data and the target product data, wherein the overage data comprises an amount to authorize in the transaction; and
transmitting transaction authorization data using the account servicing system.

3. The method of claim 2, wherein the transaction data is obtained from a payment processor system.

4. The method of claim 2, wherein the transaction authorization data is transmitted to a financial institution system, wherein the financial institution system holds the account associated with the prepaid card.

5. The method of claim 2, wherein the amount described in the overage data is equivalent to the amount of the discount applied to the product to be purchased calculated based on price data describing the cost of the target product and the offer data.

6. The method of claim 2, further comprising:
transmitting deposit data to a financial institution system holding the account associated with the prepaid card using the account servicing server system, wherein the deposit data comprises an amount of money to be deposited into the account based on the offer data; and
the transaction authorization data comprises instructions to a payment processor system to re-execute the financial transaction.

7. The method of claim 2, wherein the transaction authorization data comprises metadata describing an authorization to allow an overage on the financial transaction based on the offer data.

8. The method of claim 1, wherein:
the method further comprises identifying a client device associated with the prepaid card based on the financial transaction data using the account servicing server system; and
the advertising data is provided to the client device.

9. The method of claim 8, wherein providing the advertising data further comprises:
transmitting the targeting data to a third party advertising system using the account servicing server system; and
transmitting the advertising data to the client device using the third-party advertising system.

10. The method of claim 1, wherein generating targeting data further comprises:
identifying at least one offer in a set of offer data comprising offer keywords corresponding to the attribute/value pair data in the target product data using the account servicing server system; and
generating the targeting data based on the offer keywords and the target product data using the account servicing server system.

11. The method of claim 10, wherein the offer data is obtained from a retailer system.

12. The method of claim 10, wherein the offer data is obtained from a third-party advertising system.

13. The method of claim 10, wherein:
the target product data further comprises price data describing the price of the target product; and
generating the targeting data is further based on the price data and the target product account balance data.

14. The method of claim 13, further comprising calculating the difference between the price data and the target price account balance data using the account servicing server system.

15. The method of claim 10, wherein:
the target product data further comprises location data describing the location of the target product; and
generating the targeting data is further based on the location data.

16. The method of claim 1, wherein obtaining advertising data further comprises generating the advertising data based on the targeting data using the account servicing server system.

17. The method of claim 1, wherein obtaining advertising data further comprises:
transmitting the targeting data to a third-party advertising system using the account servicing server system; and
receiving the advertising data from the third-party advertising system using the account servicing server system.

18. The method of claim 1, wherein the advertising data is provided by the account servicing server system.

19. The method of claim 1, wherein the advertising data is provided by a retailer system.

20. An account servicing server system, comprising:
a processor; and
a memory connected to the processor and storing an account servicing application;
wherein the account servicing application directs the processor to:
obtain target product data comprising a set of attribute/value pair data describing a target product;
obtain target product account data comprising an indication of the funds available to spend on the target product;
generate targeting data based on the target product data and the target product account data;
obtain advertising data based on the targeting data; and
provide the advertising data.
